(19) United States
(12) Patent Application Publication
(10) Pub. No.: US 2011/0059306 A1
(43) Pub. Date: Mar. 10, 2011

(54) REFLECTIVE CRACK RELIEF LAYER THAT IS PERMEABLE

(75) Inventors: Phillip Blankenship, Richmond, KY (US); Richard Steger, Broken Arrow, OK (US); James Campbell, Sedgwick, KS (US)

(73) Assignee: ROAD SCIENCE, LLC, Tulsa, OK (US)

(21) Appl. No.: 12/949,471

(22) Filed: Nov. 18, 2010

Related U.S. Application Data
(63) Continuation-in-part of application No. 12/182,547, filed on Jul. 30, 2008.

(51) Int. Cl. C08L 95/00; B32B 11/00

(52) U.S. Cl. 428/220; 106/281.1; 106/284.01

(57) ABSTRACT

A design method for making a bituminous mixture that is used to form a vapor-permeable layer of pavement is provided. This design procedure includes preparing one or more bituminous mixture test specimens, measuring the performance of these specimens, and selecting a desirable bituminous mixture for paving that is vapor-permeable based on the performance of the specimens. Another aspect of the present invention is the selected bituminous mixture, which includes aggregate and a bituminous binder. The aggregate may be selected such that no more than about 5% by mass of the aggregate and preferably no more than about 3.5% by mass of the aggregate is able to pass through a 75 μm sieve. The selected bituminous mixture may have an Air Permeability Value that is at least about 8 cm² so as to reduce its propensity for blistering during and after construction. Still further, the selected bituminous mixture may have desirable fatigue resistance and may be substantially water-impermeable.

### CROSS-REFERENCE TO RELATED APPLICATIONS

This application is a continuation-in-part of application Ser. No. 12/182,547 filed Jul. 30, 2008 titled “Reflective Crack Relief Layer that is Permeable,” which itself is a continuation of application Ser. No. 11/195,900 filed Aug. 3, 2005 titled “Reflective Crack Relief Layer that is Permeable.” Both applications are incorporated by reference herein as if reproduced in full below.

### BACKGROUND OF THE INVENTION

1. Field of the Invention.

The present invention relates to a bituminous mixture for paving applications. More specifically, this bituminous mixture provides a paved layer with increased vapor permeability while the layer remains substantially moisture impervious and retains its ability to retard the formation of reflective cracks.

2. Description of the Related Art.

When pavements deteriorate, they may be overlaid with hot mix asphalt (HMA) to repair them. When designing an overlay, the rate of crack propagation through the overlay, the rate of deterioration of the reflective crack, and the amount of water that can infiltrate through the crack must be considered. One disadvantage with such thicker HMA overlays is that cracks in the old pavement reflect through the new overlay. To relieve this reflective cracking, one option is to place thicker overlays. Another disadvantage with conventional HMA overlays is that they are water permeable allowing water to enter the base. A third disadvantage with these overlays is that they typically have a low strain tolerance and a low resistance to reflective cracking.

Asphalt binders that display the ability to undergo creep or stress relaxation at low temperatures in order to minimize the potential for thermal and reflective cracking may be created. The disadvantage with such binders is that they are highly ductile and thus, roads created with them tend to rut.

Asphalt binders with a high shear modulus that resist rutting at high temperatures also may be created. The disadvantage with such binders is that they tend to be brittle at low temperatures, and thus, roads created with them tend to crack. Typical asphalt binders formulated for pavement applications usually display either high sheer modulus at high temperatures or high ductilities at low temperatures but not both.

Other reflective crack control measures that are used to rehabilitate distressed pavements include placing Stress-Absorbing Membrane Interlayers (SAMI), placing grids or fabrics on a surface before placing HMA, break and seat of the pavement, rubblization of the pavement, and reconstruction. Some potential disadvantages with these processes are that they can be cost prohibitive, ineffective, difficult to recycle, or difficult to construct. Another disadvantage with these processes is that if the road is not reconstructed, it may still have cracking problems.

In order to solve some of the problems discussed above, interlayers have been created that have the ability to relax stress while maintaining stability. An example of such an interlayer is described in U.S. Pat. No. 6,860,408, which is incorporated by reference in its entirety. Such an interlayer has an aggregate structure that includes a large amount of fine aggregate. More specifically, 6 to 14% of aggregate used in such an interlayer is able to pass through a No. 200 sieve and 100% of aggregate is able to pass through a 9.5 mm sieve. While such an interlayer is impermeable to water so as to prevent surface water from penetrating and collecting below it, it has the disadvantage of being substantially impermeable to vapor. When such an interlayer is placed on Portland Cement Concrete (PCC) or another paved surface, the interlayer has the potential to trap vapor underneath it. As changes occur in climatic and environmental conditions, this causes the PCC to release moisture or vent. The interlayer then rises creating a blister. This causes overlays on top of this interlayer also to rise and blister. Through experimentation, the inventors of the present invention have determined that water vapor is a predominant component of the vapor that creates the blisters.

In order to overcome these disadvantages, a bituminous mixture that is able to form a layer that remains substantially moisture impervious and retains its ability to retard the formation of reflective cracks while having increased vapor permeability is needed. This bituminous mixture should be able to be used to create various layers of a roadway including base layers, interlayers, and overlays.

### BRIEF SUMMARY OF THE INVENTION

In general, in a first aspect, the present invention relates to a bituminous mixture, comprising a mixture of aggregate and a bituminous binder. The bituminous mixture has at least 4% air voids, an Air Permeability Value that is at least 8 cm², and a Flexural Beam Fatigue of at least 5,000 cycles at 2000 microstrains, 10 Hz, and 20° C. The bituminous mixture may have a Flexural Beam Fatigue of at least 35,000 cycles, or an Air Permeability Value that is at least 10 cm². The bituminous mixture may have a dust/bitumen ratio that is no more than 0.9. At least 7% of the bituminous mixture may be the binder. The binder may have a film thickness of at least 7 μm. The bituminous mixture may have at least 5% air voids.

A bituminous mixture may comprise a mixture of aggregate, wherein no more than 5% of the aggregate is able to pass through a 75 μm sieve and more than 70% of the aggregate is able to pass through a 2.36 mm sieve; and a bituminous binder, wherein the mixture has at least 4% air voids and a Flexural Beam Fatigue that is at least 5000 cycles at 2000 microstrains, 10 Hz, and 20° C. More than 85% of the aggregate may be able to pass through a 2.36 mm sieve, or no more than 7% of the aggregate may be able to pass through a 150 μm sieve and at least 90% may be able to pass through a 9.5 mm sieve. The bituminous mixture may have at least 5% air voids. The bituminous mixture may have no more than 70% voids filled with bitumen. The bituminous mixture may have a dust/bitumen ratio that is no more than 0.9. No more than 25% of the aggregate may be able to pass through a 600 μm sieve. The binder may have a film thickness of at least 7 μm. The bituminous mixture may have at least 18% VMA.

A bituminous mixture may comprise a mixture of aggregate, wherein no more than 5% of the aggregate is able to pass through a 75 μm sieve; and a bituminous binder, wherein the mixture has at least 4% air voids and an Air Permeability Value that is at least 8 cm². The bituminous mixture may have at least 5% air voids. At least 7% of the bituminous mixture may be binder. The bituminous mixture may have a Flexural Beam Fatigue of at least 5,000 cycles at 2000 microstrains, 10 Hz, and 20° C. The bituminous mixture may have no more than 70% voids filled with bitumen. The bituminous mixture may have a film thickness of at least 7 μm.

A method of making a bituminous mixture comprises selecting aggregate wherein no more than 5% by mass of the aggregate is able to pass through a 75 μm sieve; and mixing bituminous binder and the aggregate to form a bituminous mixture, wherein the bituminous mixture has at least 4% air voids and has substantial vapor permeability and wherein the bituminous mixture has a Flexural Beam Fatigue of at least 5,000 cycles at 2000 microstrains, 10 Hz, and 20° C. The bituminous mixture may have an Air Permeability Value that is at least 8 cm².

A method of selecting a bituminous mixture for making a layer for a roadway comprises providing aggregate wherein no more than 5% by mass of the aggregate is able to pass through a 75 μm sieve; providing at least one bituminous mixture comprised of a bituminous binder and the aggregate; performing a fatigue test on the at least one bituminous mixture; performing a permeability test on the at least one bituminous mixture; and selecting a bituminous mixture for the layer after performing the fatigue and permeability tests based on fatigue and permeability performance of the at least one bituminous mixture, wherein aggregate in the selected bituminous mixture is sufficiently large so as to create at least 4% air voids in the bituminous mixture and allow for substantial permeability in the mixture. At least 90% by mass of the aggregate in the selected bituminous mixture may be able to pass through a 9.5 mm sieve, and substantially all of the aggregate in the selected bituminous mixture may be able to pass through a 12.5 mm sieve. The selected bituminous mixture may have an Air Permeability Value that is at least 8 cm² or a Flexural Beam Fatigue of at least 5000 cycles at 2000 microstrains, 10 Hz, and 20° C. The method may further comprise determining amount of voids filled with bitumen in the at least one bituminous mixture before the selection step and selecting the bituminous mixture based on the determination. The method may further comprise determining amount of air voids in the at least one bituminous mixture before the selection step and selecting the bituminous mixture based on the determination. The method may further comprise determining dust/bitumen ratio of the at least one bituminous mixture before the selection step and selecting the bituminous mixture based on the determination.

A fatigue-resistant and vapor-permeable layer of roadway comprises: a mixture of: aggregate, wherein no more than 5% by mass of the aggregate is able to pass through a 75 μm sieve and more than 70% is able to pass through a 2.36 mm sieve; and a bituminous binder, wherein the layer has at least 4% air voids, an Air Permeability Value of at least 8 cm², and a Flexural Beam Fatigue of at least 5000 cycles at 2000 microstrains, 10 Hz, and 20° C. in the first 24 hours after being placed. The bituminous mixture may have no more than 70% voids filled with bitumen. The layer may have at least 18% VMA.

### DETAILED DESCRIPTION OF PREFERRED EMBODIMENT

A design method for making a paved layer that has fatigue resistance while being vapor-permeable is described. More specifically, the layer may be relatively impermeable to water while being relatively permeable to vapor.

A method of selecting a bituminous mixture for making a layer of a roadway is provided. This method may include preparing test specimens of one or more bituminous mixtures, constructing various performance tests on the bituminous mixtures, and selecting a bituminous mixture having desirable qualities for making a vapor-permeable layer based on the results of the performance tests that were conducted on the specimens. The selected bituminous mixture may meet certain criteria, and the aggregate chosen for the use in the selected bituminous mixture may meet certain criteria.

The aggregate selected for inclusion in the bituminous mixture that undergoes performance screening may include no more than about 5% by mass of aggregate that is able to pass through a 75 μm (No. 200) sieve. Preferably, no more than about 4.5% by mass of aggregate is able to pass through a 75 μm sieve. More preferably, no more than about 4% by mass of aggregate is able to pass through a 75 μm sieve. Most preferably, no more than about 3.5% by mass of aggregate in the bituminous mixture is able to pass through 75 μm sieve. Preferably, no more than about 7% by mass of the aggregate in the bituminous mixture is able to pass through a 150 μm (No. 100) sieve. More preferably, no more than about 6% by mass of the aggregate is able to pass through a 150 μm sieve. Most preferably, no more than about 5% by mass of the aggregate is able to pass through a 150 μm sieve. Preferably, more than about 25% by mass of the aggregate is able to pass through a 600 μm (No. 30) sieve and more than about 45% by mass of the aggregate is able to pass through a 1.8 mm (No.16) sieve. Preferably, more than about 70% by mass of aggregate is able to pass through a 2.36 mm (No. 8) sieve. More preferably, more than about 80% by mass of the aggregate is able to pass through a 2.36 mm sieve. Most preferably, more than about 85% by mass of the aggregate is able to pass through a 2.36 mm sieve. Preferably, at least about 90% by mass of the aggregate is able to pass through the 9.5 mm sieve. Substantially all of the aggregate selected may be able to pass through a 12.5 mm sieve. The aggregate may include, but is not limited to, mineral aggregates, such as sand, stone, and/or lime, and may be crushed and/or rounded.

One or more bituminous mixtures may be created from the selected aggregate. The binder used to make the bituminous mixture may provide good resistance to rutting and cracking. Preferably, polymer-modified or elastomer-modified binders may be used. Binders as described in U.S. Pat. No. 6,830,408 may be used. Preferably, multiple mixtures may be made so that the effects of different proportions of various aggregate gradations, different binders, and different binder amounts can be observed through the performance tests conducted.

Preferably, the bituminous mixture includes at least about 7% by weight bituminous binder. Most preferably, it includes at least about 8% by weight bituminous binder. Most preferably, it includes at least about 9% by weight bituminous binder.

Specimens may be created from the proposed bituminous mixtures. These specimens may have approximately the same amount of air voids as the amount desired in the layer of pavement to be constructed.

Physical properties of the specimens of bituminous mixtures may be measured, and performance tests may be performed. At least one performance test may be conducted or physical property may be measured on at least one of the bituminous mixtures that have been made. This performance test may be a fatigue resistance test or a vapor permeability test. Preferably, a Flexural Beam Fatigue test may be performed to measure fatigue resistance. Preferably, the vapor permeability test is based on measuring a sample that has a percentage of air voids that is substantially equal to the desired percentage of air voids in the layer of pavement to be created. Preferably, the vapor permeability test is an Air Permeability test. Preferably, the Air Permeability test is based on measuring a sample that is 2.5 cm in height and 10 cm in diameter. Most preferably, the Standard Test Methods for Permeability of Bituminous Mixtures (ASTM D 3637), which measures the rate at which air can be forced or drawn through a bituminous mixture, is followed. Physical qualities measured or calculated may include air voids, bitumen film thickness, voids filled with bitumen, voids in the mineral aggregate (VMA), and dust to binder ratio (D/B). VMA may be measured no matter what material(s) is used as the aggregate, whether mineral aggregate or not. Preferably, dust to binder ratio is calculated by following volumetric design procedures outlined in section 9.3.6 of AASHTO R 35-04, where this ratio is defined as dust to estimated effective binder content. Preferably, more than one of the physical qualities discussed above is measured or calculated and all of the performance tests discussed above are conducted on the test specimens. Most preferably, all of the measurements discussed above are taken and all of the performance tests discussed above are conducted on the test specimens.

Based on the performance tests, measurements, and calculations discussed above, a bituminous mixture for making a layer of pavement may be selected. If a desirable bituminous mixture was tested, the exact same bituminous mixture may be selected for making the layer. If an undesirable bituminous mixture was tested, then the aggregate gradation composition, binder amount, and/or binder composition may be modified so as to compensate for the undesirable performance or physical property of the tested specimen of bituminous mixture.

The selected bituminous mixture may include an aggregate and binder constituency that creates at least about 3% air voids in the bituminous mixture based on 50 gyrations compaction of a 100 mm sample. Preferably, the bituminous mixture has at least about 4.0% air voids. More preferably, the bituminous mixture has at least about 4.5% air voids. Even more preferably, the bituminous mixture has at least about 5% air voids. Most preferably, at least about 7% air voids are created in the bituminous mixture.

Preferably, the selected bituminous mixture has an Air Permeability Value of at least about 8 cm². More preferably, the selected mixture has an Air Permeability Value of at least about 10 cm². More preferably, the selected mixture has an Air Permeability Value of at least 12 cm². Most preferably, the selected mixture has an Air Permeability Value of at least 15 cm².

The selected bituminous mixture may have a Flexural Beam Fatigue at 2000 microstrains, 10 Hz, and 20° C. of at least about 5000 cycles. More preferably, the Flexural Beam Fatigue of the bituminous mixture may be at least about 35,000 cycles. Most preferably, the Flexural Beam Fatigue of the bituminous mixture may be at least about 100,000 cycles.

No more than about 5% by mass of the aggregate included in the selected bituminous mixture may be able to pass through a 75 μm sieve. Preferably, no more than about 4.5% by mass of aggregate may be able to pass through a 75 μm sieve. More preferably, no more than about 4% by mass of aggregate may be able to pass through a 75 μm sieve. Most preferably, no more than 3.5% by mass of aggregate in the bituminous mixture may be able to pass through a 75 μm sieve. Preferably, no more than about 7% by mass of aggregate in the bituminous mixture may be able to pass through 150 μm sieve. More preferably, no more than about 6% by mass of the aggregate may be able to pass through a 150 μm sieve. Most preferably, no more than about 5% by mass of the aggregate may be able to pass through a 150 μm sieve. Preferably, more than about 25% by mass of aggregate may be able to pass through a 600 μm sieve and more than about 45% by mass of the aggregate may be able to pass through a 1.18 mm sieve. Preferably, more than about 70% by mass of the aggregate may be able to pass through a 2.36 mm sieve. More preferably, more than about 80% by mass of the aggregate may be able to pass through a 2.36 mm sieve. Most preferably, more than about 85% by mass of the aggregate may be able to pass through a 2.36 mm sieve. Preferably, at least about 90% by mass of the aggregate may be able to pass through a 9.5 mm sieve. Substantially all of the aggregate selected may be able to pass through a 12.5 mm sieve. The aggregate in the selected bituminous mixture may include, but is not limited to, mineral aggregates, such as sand, stone, and/or lime, and may be crushed and/or rounded.

The selected bituminous mixture may have no more than about 70% voids filled with bitumen. Preferably, it has no more than about 65% voids filled with bitumen. In some instances, it has no more than about 60% voids filled with bitumen. Most preferably, it has about 65% voids filled with bitumen for optimal fatigue resistance.

The aggregate used in the selected bituminous mixture may have at least about 18% VMA. Preferably, it has at least about 20% VMA, and most preferably, it has at least about 22% VMA.

The dust to bitumen ratio (D/B) of the selected bituminous mixture may be no more than about 0.9. Preferably, the dust to bitumen ratio is no more than about 0.7. Most preferably, the dust to bitumen ratio is no more than about 0.5.

The selected bituminous mixture may have a bitumen film thickness of at least about 7 μm. Preferably, the film thickness of the selected bituminous mixture is at least about 8 μm, and most preferably, it is at least 9 μm.

Another aspect of the present invention may be a bituminous mixture that includes aggregate and a bituminous binder. This bituminous mixture may be able to be used to make a layer of pavement that has good fatigue resistance while being substantially water-impermeable and vapor-permeable.

There is an inverse relationship between the air voids in a bituminous mixture and fatigue resistance of that mixture. There are many references that describe high air void bituminous mixes that are fatigue intolerant. Also, bituminous mixes have been made that have excellent fatigue resistance but very low air voids so as to be essentially vapor impermeable. Until the present invention, the inverse relationship between air voids and fatigue resistance was thought to be an immutable inherent property. In the present invention, it was surprising to find that a bituminous mixture with desirable permeability and fatigue resistance can be created.

A fatigue-resistant, substantially water-impermeable, substantially vapor-permeable layer of a roadway may be created from the bituminous mixture of the present invention. The bituminous mixture can be used for various paving applications. It can be used to make base layers, interlayers, and overlays. Paved layers created with the bituminous mixture of the present invention have a reduced propensity for blistering during and after construction. In addition, the ability of such layers to relax stress is not overly compromised. Thus, such layers have the ability to retard the formation and severity of reflective cracks. Further, such layers are durable. The bituminous mixture of the present invention can be placed on a roadway with conventional equipment.

The following is an example of a paved area using a bituminous mixture of the present invention that has been compared with an invented interlayer similar to what is described in U.S. Pat. No. 6,830,408. This example is not meant in any way to limit the scope of this invention.

### EXAMPLE 1

A paved interlayer of a preferred embodiment of the present invention, which will be referred to as Section 1, was constructed on K-15 in Wichita, Kans. between 1-35 and the Kansas Turnpike bridge. Section 2 was built on 1-435 in Kansas. It encompassed an interlayer that did not have significant vapor permeability and closely resembled the interlayer described in U.S. Pat. No. 6,830,408. An overlay of PG 70-28 asphalt was placed over both interlayer sections.

The interlayer of Section 1 was one-inch thick and contained an average of 8.5% by weight binder. Section 2 included a one-inch interlayer averaging 9.3% by weight binder. The gradations of aggregate used in the interlayers of Sections 1 and 2 are shown in Table 1 below:

TABLE 1

| Gradations | | Section 1 | Section 2 |
|---|---|---|---|
| (sieve sizes) | | (% passing) | (% passing) |
| 9.5 | mm | 100 | 100 |
| 4.75 | mm | 98 | 96 |
| 2.36 | mm | 80 | 76 |
| 1.18 | mm | 58 | 57 |
| 600 | μm | 37 | 39 |
| 150 | μm | 4 | 11 |
| 75 | μm | 2.3 | 9 |

Characteristics of the bituminous mixtures used in Sections 1 and 2 are shown below:

TABLE 2

| | Section 1 | Section 2 |
|---|---|---|
| % binder (target) | 8.5 | 9.8 |
| % Air voids @ 50 gyrations | 5.1 | 1.3 |
| % voids in the mineral aggregate—VMA | 20.9 | 19.6 |
| Dust/bitumen ratio | 0.3 | 1.1 |
| Beam Fatigue Cycles | >170K | >100K |
| (at 2000 microstrains, 10 Hz, and 20° C.) | | |
| Air Permeability Value (cm²) | 17 | 1.5 |

The example above details the use of substantially equivalent aggregate material and binders on both experimental sections. The projects were built on substantially similar concrete structures, in similar climatic areas and high traffic volumes. Section 1 constructed well and has performed well. Section 2 trapped water vapor between the substantially vapor impermeable interlayer and the concrete causing extreme blistering. The extreme blistering necessitated the complete removal of the interlayer.

From the foregoing it will be seen that this invention is one well adapted to attain all ends and objectives hereinabove set forth, together with the other advantages which are obvious and which are inherent to the invention.

Since many possible embodiments may be made of the invention without departing from the scope thereof, it is to be understood that all matters herein set forth are to be interpreted as illustrative, and not in a limiting sense.

While specific embodiments have been shown and discussed, various modifications may of course be made, and the invention is not limited to the specific forms or arrangement of parts and steps described herein, except insofar as such limitations are included in the following claims. Further, it will be understood that certain features and subcombinations are of utility and may be employed without reference to other features and subcombinations. This is contemplated by and is within the scope of the claims. While presently preferred embodiments of the invention have been described for purposes of this disclosure, it will be understood that numerous changes may be made which will readily suggest themselves to those skilled in the art and which are accomplished within the spirit of the invention disclosed and claimed.

What is claimed is:

1. A bituminous mixture, comprising a mixture of:
aggregate; and
a bituminous binder, wherein the bituminous mixture has at least 4% air voids, an Air Permeability Value that is at least 8 cm², and a Flexural Beam Fatigue of at least 5,000 cycles at 2000 microstrains, 10 Hz, and 20° C.

2. The bituminous mixture of claim 1 wherein the bituminous mixture has a Flexural Beam Fatigue of at least 35,000 cycles at 2000 microstrain, 10 Hz, and 20° C.

3. The bituminous mixture of claim 2 wherein the bituminous mixture has an Air Permeability Value that is at least 10 cm².

4. The bituminous mixture of claim 1 wherein the bituminous mixture has a dust/bitumen ratio that is no more than 0.9.

5. The bituminous mixture of claim 1 wherein at least 7% of the bituminous mixture is the binder.

6. The bituminous mixture of claim 1 wherein the binder has a film thickness that is at least 7 μm.

7. The bituminous mixture of claim 1 wherein the bituminous mixture has at least 5% air voids.

8. A bituminous mixture, comprising a mixture of:
aggregate, wherein no more than 5% of the aggregate is able to pass through a 75 μm sieve and more than 70% of the aggregate is able to pass through a 2.36 mm sieve; and
a bituminous binder, wherein the mixture has at least 4% air voids and a Flexural Beam Fatigue that is at least 5000 cycles at 2000 microstrains, 10 Hz, and 20° C.

9. The bituminous mixture of claim 8 wherein more than 85% of the aggregate is able to pass through a 2.36 mm sieve.

10. The bituminous mixture of claim 8 wherein no more than 7% of the aggregate is able to pass through a 150 μm sieve and at least 90% is able to pass through a 9.5 mm sieve.

11. The bituminous mixture of claim 8 wherein the bituminous mixture has at least 5% air voids.

12. The bituminous mixture of claim 8 wherein the bituminous mixture has no more than 70% voids filled with bitumen.

13. The bituminous mixture of claim 8 wherein the bituminous mixture has a dust/bitumen ratio that is no more than 0.9.

14. The bituminous mixture of claim 8 wherein no more than 25% of the aggregate is able to pass through a 600 μm sieve.

15. The bituminous mixture of claim 8 wherein the binder has a film thickness of at least 7 μm.

16. The bituminous mixture of claim 8 wherein the bituminous mixture has at least 18% VMA.

17. A bituminous mixture, comprising a mixture of:
aggregate, wherein no more than 5% of the aggregate is able to pass through a 75 μm sieve; and
a bituminous binder, wherein the mixture has at least 4% air voids and an Air Permeability Value that is at least 8 cm².

18. The bituminous mixture of claim 17 wherein the bituminous mixture has at least 5% air voids.

19. The bituminous mixture of claim 17 wherein at least 7% of the bituminous mixture is binder.

20. The bituminous mixture of claim 17 wherein the bituminous mixture has a Flexural Beam Fatigue of at least 5,000 cycles at 2000 microstrains, 10 Hz, and 20° C.

21. The bituminous mixture of claim 17 wherein the bituminous mixture has no more than 70% voids filled with bitumen.

22. The bituminous mixture of claim 17 wherein the bituminous mixture has a film thickness of at least 7 μm.

23. A method of making a bituminous mixture, comprising:
selecting aggregate wherein no more than 5% by mass of the aggregate is able to pass through a 75 μm sieve; and
mixing bituminous binder and the aggregate to form a bituminous mixture, wherein the bituminous mixture has at least 4% air voids and has substantial vapor permeability and wherein the bituminous mixture has a Flexural Beam Fatigue of at least 5,000 cycles at 2000 microstrains, 10 Hz, and 20° C.

24. The method of claims 23 wherein the bituminous mixture has an Air Permeability Value that is at least 8 cm².

25. A method of selecting a bituminous mixture for making a layer for a roadway, comprising:
providing aggregate wherein no more than 5% by mass of the aggregate is able to pass through a 75 μm sieve;
providing at least one bituminous mixture comprised of a bituminous binder and the aggregate;
performing a fatigue test on the at least one bituminous mixture;
performing a permeability test on the at least one bituminous mixture; and
selecting a bituminous mixture for the layer after performing the fatigue and permeability tests based on fatigue and permeability performance of the at least one bituminous mixture, wherein aggregate in the selected bituminous mixture is sufficiently large so as to create at least 4% air voids in the bituminous mixture and allow for substantial permeability in the mixture.

26. The method of claim 25 wherein at least 90% by mass of the aggregate in the selected bituminous mixture is able to pass through a 9.5 mm sieve, and substantially all of the aggregate in the selected bituminous mixture is able to pass through a 12.5 mm sieve.

27. The method of claim 25 wherein the selected bituminous mixture has an Air Permeability Value that is at least 8 cm².

28. The method of claim 25 wherein the selected bituminous mixture has a Flexural Beam Fatigue of at least 5000 cycles at 2000 microstrains, 10 Hz, and 20° C.

29. The method of claim 25, further comprising determining amount of voids filled with bitumen in the at least one bituminous mixture before the selection step and selecting the bituminous mixture based on the determination.

30. The method of claim 25, further comprising determining amount of air voids in the at least one bituminous mixture before the selection step and selecting the bituminous mixture based on the determination.

31. The method of claim 25, further comprising determining dust/bitumen ratio of the at least one bituminous mixture before the selection step and selecting the bituminous mixture based on the determination.

32. A fatigue-resistant and vapor-permeable layer of roadway, comprising:
a mixture of: aggregate, wherein no more than 5% by mass of the aggregate is able to pass through a 75 μm sieve and more than 70% is able to pass through a 2.36 mm sieve; and
a bituminous binder, wherein the layer has at least 4% air voids, an Air Permeability Value of at least 8 cm², and a Flexural Beam Fatigue of at least 5000 cycles at 2000 microstrains, 10 Hz, and 20° C. in the first 24 hours after being placed.

33. The layer of claim 32 wherein the bituminous mixture has no more than 70% voids filled with bitumen.

34. The layer of claim 32 wherein the layer has at least 18% VMA.
